(19) United States
(12) Patent Application Publication
(10) Pub. No.: US 2026/0214433 A1
(43) Pub. Date: Jul. 23, 2026

(54) SYSTEM COMPRISING AN INTERMITTENTLY ACTIVE BEACON DEVICE

(71) Applicant: Accessia Technology Ltd, London (GB)

(72) Inventor: Paul Richard WITTY, Virginia Water (GB)

(73) Assignee: Accessia Technology Ltd, London (GB)

(21) Appl. No.: 19/456,454

(22) Filed: Jan. 22, 2026

(30) Foreign Application Priority Data
Jan. 23, 2025 (GB) 2500997.8
Dec. 19, 2025 (GB) 2522321.5

(51) Int. Cl. H04W 8/22; H04W 4/33

(52) U.S. Cl. CPC H04W 8/22; H04W 4/33

(57) ABSTRACT

A system comprising: an intermittently active beacon device having an idle state during which the intermittently active beacon device is not configured to broadcast beacon messages and an active state during which the intermittently active beacon device is configured to repeatedly broadcast a beacon message, the intermittently active beacon device being configured to intermittently enter the active state from the idle state and on entering the active state, broadcast the beacon message; and a mobile device configured to implement an operating system and an application, wherein the mobile device is configured to, upon the intermittently active beacon device entering the active state from the idle state: receive the beacon message from the intermittently active beacon device, wherein the receipt of the beacon message causes the operating system implemented by the mobile device to infer that a new beacon is visible to the operating system; and in response to causing the operating system implemented by the mobile device to infer that a new beacon is visible to the operating system, the operating system is configured to wake the application to allow the application to perform a function.

### CROSS-REFERENCE TO RELATED APPLICATIONS

The present application claims priority to UK Patent Application No. 2500997.8, filed Jan. 23, 2025, and UK Patent Application No. 2522321.5, filed Dec. 19, 2025, the contents of which are incorporated herein by reference in their entireties.

### FIELD OF THE INVENTION

This invention relates to a system comprising an intermittently active beacon device that can be used to wake an application at a mobile device.

### BACKGROUND

In the modern world of hyperconnectivity, laws to protect the online privacy of individuals are being created in many jurisdictions. This culture and these legal frameworks have in some cases caused mobile device operating system designers to be cautious about giving mobile applications access to device features that may invade the privacy of their users. However, when, for example, an application's primary purpose requires tracking of its users'location, such as for the purpose of security and access control, these mobile operating system features can be a hindrance to the normal functioning of the application.

Bluetooth Low Energy (BLE) beacons are a technology that can be used for detecting the proximity of a device. Such beacons can send a repeating message, for example at an interval of between 100 ms and 900 ms, which can be received by a compatible device that is within physical range of the beacon.

When an application on a mobile device is running, the operating system can generally perform ranging with each of the beacons that are in the vicinity of the mobile device to determine the location of the device. This generally works well for a foreground application, such as a museum tour guide application that provides commentary applicable to the exhibits in the near vicinity. However, for a background application that is usually asleep, the application relies on the operating system to inform it about detected beacons, and these notifications from the operating system can be restrictive for the privacy reasons described above.

The operating system support for beacons will alert an application, if it has subscribed to the identifier of a beacon, when the device comes into range of the beacon or goes out of range of the beacon. For a building interior with partitions constructed of lightweight materials, a beacon may have a large range, and so these indications that the device has come into range of one or more beacons may trigger as soon as the device enters the building.

Once the device is in range of a beacon, the operating system will generally not notify the application again about the presence of the beacon until the device goes out of range and re-enters the range of that beacon. If the range of the beacon is so large that the device never goes out of range whilst the user is in the building, the application will have no further opportunity to perform ranging with the nearby beacons to determine the device's precise location as the device moves through the building.

Consider an application where a mobile device is used for measuring office meeting room occupancy and a requirement is that the user should not have to interact with the device for the application to operate. The rooms of a set of rooms may each contain a beacon. When the mobile device enters the vicinity of the rooms, the application will be notified of the existence of all of the beacons and if the user promptly enters a room, then the occupancy monitoring application would have time to correctly range the beacons and identify the room that the user has occupied before the application is put to sleep by the operating system. If the user subsequently moves to an adjacent room, no further indications will be generated. Therefore, the application will not be aware of the change of location and so will report inaccurate occupancy of the room.

Furthermore, in many office spaces, meeting rooms are adjacent. Therefore, when a user approaches the meeting rooms, their device will typically be in range of every beacon. Because applications running on devices are typically woken for only a few seconds when they enter the range of a beacon, there is generally not enough time to establish which room the device is located in using signal strength measurements.

It is desirable to develop an approach that can be used to overcome at least some of the above issues.

### SUMMARY OF THE INVENTION

A system comprising: an intermittently active beacon device having an idle state during which the intermittently active beacon device is not configured to broadcast beacon messages and an active state during which the intermittently active beacon device is configured to repeatedly broadcast a beacon message, the intermittently active beacon device being configured to intermittently enter the active state from the idle state and on entering the active state, broadcast the beacon message; and a mobile device configured to implement an operating system and an application, wherein the mobile device is configured to, upon the intermittently active beacon entering the active state from the idle state: receive the beacon message from the intermittently active beacon device, wherein the receipt of the beacon message causes the operating system implemented by the mobile device to infer that a new beacon is visible to the operating system; and in response to the operating system implemented by the mobile device inferring that a new beacon is visible to the operating system, the operating system is configured to wake the application to allow the application to perform a function.

The system may have one or more of the following optional features:

The intermittently active beacon may be configured to repeatedly broadcast a beacon message in the active state according to a frequency. This frequency may be 1/t_{b}, where t_{b} is a time period between the start of each beacon message broadcast in the active state.

The frequency of broadcast of the beacon message in the active state may be greater than the frequency of entering the active state from the idle state.

The frequency of broadcast of the beacon message in the active state may be greater than the frequency of changing between the active state and the idle state (i.e. from the active state to the idle state, or vice versa).

The intermittently active beacon device may operate according to a duty cycle comprising an active time during which the intermittently active beacon device is in the active state and an idle time during which the intermittently active beacon device is in the idle state. The idle time may be greater than a predetermined time period, which may be predetermined by the operating system of the mobile device. The predetermined time period may be the length of time the operating system of a mobile device is configured to wait after receiving the last beacon message from a respective beacon before making the determination that the mobile device is no longer within range of the respective beacon. This time period is referred to herein as a beacon lost timeout of the operating system of the mobile device (which may be at least 20 seconds). In other words, the idle time may be at least 20 seconds.

The frequency of broadcast of the beacon message in the active state may be greater than the frequency of entering the active state from the idle state. The frequency of entering the active state from the idle state occurs on the passing of a time period corresponding the length of the duty cycle. The length of the duty cycle may be, for example, between 1 minute and 1 hour. The frequency of entering the active state from the idle state may occur on the passing of a time period greater than a predetermined time period, such as a beacon lost timeout of the operating system of the mobile device (which may be at least 20 seconds).

In the active state, the intermittently active beacon device is configured to repeatedly broadcast a beacon message. The intermittently active beacon may broadcast the beacon message multiple times in the active state before returning to the idle state. The frequency of broadcast of the beacon messages in the active state may be, for example, between 1-10 Hz.

The mobile device may be configured to monitor region identifiers of received beacon messages and wherein the beacon message received from the intermittently active beacon device contains a first region identifier, wherein when the mobile device receives the beacon message containing the first region identifier, the operating system is configured to wake the application to inform the application that the mobile device is in an area corresponding to the first region identifier.

When the mobile device has not detected a beacon message containing the first region identifier for at least a predetermined period, the operating system may be configured to wake the application to inform the application that the mobile device is no longer in an area corresponding to the first region identifier.

The intermittently active beacon device may be configured to regularly broadcast the beacon message in the active state.

The function comprises determining the location of the mobile device. The mobile device may determine the location directly, or may determine the location by sending information to another entity to perform one or more calculations.

The system may comprise one or more positioning beacons, wherein the mobile device is located so as be able to receive respective signals from the one or more positioning beacons, wherein the application is configured to request the operating system to perform one or more measurements of the signals received from the one or more positioning beacons.

The system may comprise a computing entity configured to determine, in dependence on the measurements of the signals received from the one or more positioning beacons, a status of the mobile device and/or one or more of the positioning beacons.

The mobile device may be configured to determine in which of multiple rooms the device is located based on the determined location.

The one or more measurements may be signal strength measurements.

The mobile device may be configured to: perform two-way ranging with at least one of the one or more positioning beacons; and determine the location of the mobile device based on the two-way ranging. This may be performed using ultra-wideband (UWB) signals.

The mobile device may be further configured to, in dependence on the determined location, perform an action.

The action may comprise establishing a connection with an entity external to the mobile device. The entity may be in proximity to the determined location. The entity may be within a predetermined range of the determined location.

The mobile device may be configured to report the determined location to another entity. The another entity may be external to the mobile device.

The one or more positioning beacons and/or the intermittently active beacon device may comprise a Bluetooth Low Energy beacon publisher.

In the idle state, the intermittently active beacon device may be configured to save its current state to memory and shut down other components of the intermittently active beacon device.

The intermittently active beacon device may be configured to periodically and/or continuously enter the active state from the idle state.

The idle state may be a low-power state.

The mobile device may be configured to: in response to receiving the beacon message and waking the application, perform one or more measurements with the one or more positioning beacons; and determine the location of the mobile device based on the one or more measurements. The measurements may be requested or performed by the operating system. The one or more measurements may be signal strength measurements. The communication between the mobile device and the one or more positioning beacons may comprise receiving a message from each of the positioning beacons. From the received message(s), the mobile device may be configured to determine its location based on received signal strength indicators (RSSI) determined for each positioning beacon.

The intermittently active beacon device and/or the one or more positioning beacons may be configured to transmit signals, such as messages. The one or more positioning beacons and/or the intermittently active beacon device may not be configured to receive signals. The communication between the mobile device and the one or more positioning beacons may be one-way. The communication may be from a respective positioning beacon to the mobile device. For example, each positioning beacon may broadcast a message that is received at the mobile device.

In some implementations, the intermittently active beacon device and/or the one or more positioning beacons may be configured to transmit and receive signals. The communication between the mobile device and the one or more positioning beacons may be two-way. For example, the intermittently active beacon device and/or the positioning beacons may be configured to send messages and may also be able to receive messages from the mobile device. In response to receiving the beacon message, the mobile device may be configured to perform one-way or two-way ranging with at least one of the one or more positioning beacons; and determine the location of the mobile device based on the one-way or two-way ranging.

The mobile device may be further configured to, in dependence on the determined location, perform an action.

The action may comprise establishing a connection with a piece of equipment, such as a piece of computing equipment. In some instances, the equipment may be part of a videoconferencing system or a piece of audiovisual equipment. The piece of equipment may be in proximity to the determined location.

The piece of equipment may be within a predetermined range of the determined location.

The determined location of the mobile device may be used to establish the proximity of the mobile device to a piece of equipment. The mobile device may be configured to trigger a connection to allow control of, and/or data sharing with, the piece of equipment.

The mobile device may be configured to determine in which of multiple rooms the device is located based on the determined location.

The mobile device may be configured to report the determined location to another entity, such as a room occupation monitoring entity or real time location system for a building or part thereof. The room occupation monitoring entity or real time location system may monitor the occupancy of rooms within the building or part thereof. The entity may be an entity external to the mobile device. Alternatively, the entity may be another application running on the mobile device.

In some implementations, the system may comprise the room occupation monitoring entity or the real time location system and the system may be a room occupation monitoring system or a real time location system for a building or part thereof.

The mobile device may be associated with a user and the determined location may be reported to another entity with a user identifier associated with the user. This may, for example, allow a room allocation entity or a real time location system to determine which users are currently located in particular rooms.

The intermittently active beacon device may be located within a room. The one or more positioning beacons may each be located within a respective room. The rooms may be rooms of the building or part thereof.

The location of the mobile device may be determined as being closest to a particular positioning beacon of the one or more positioning beacons. The particular positioning beacon may be associated with (for example, located within) a particular room. The mobile device may be determined to be in the room corresponding to the particular positioning beacon. This may be used to determine which room a user associated with a mobile device is located in.

In response to receiving the beacon message at the mobile device, the application may cause the mobile device to communicate with the one or more of the positioning beacons.

The reception of the beacon message may cause the application on the mobile device to be activated.

In response to the mobile device receiving the beacon message from the intermittently active beacon device, the operating system of the mobile device may be configured to send a notification to the application that a new (previously unseen according to a list of beacons available to the operating system) beacon is in range of the mobile device.

The application may be configured to request the operating system to communicate with all positioning beacons within range of the mobile device. It may do this in response to receiving the notification.

The application may be configured to determine the location of the mobile device using data (for example, measurements such as signal strength measurements) received from the operating system of the mobile device.

The application may determine the location of the mobile device as being in one of multiple rooms of the building. The application may report the determined room to the room occupation entity. In response, the room occupation entity may update a room occupation status. The application or the room monitoring entity may compare the determined location with a map of the building or part thereof and determine which room the mobile device is located in based on the comparison.

The one or more positioning beacons may be Bluetooth Low Energy beacons.

The intermittently active beacon device may comprise a Bluetooth Low Energy beacon publisher.

In the idle state, the intermittently active beacon device may be configured to save its current state to memory and/or shut down other components of the intermittently active beacon device.

The intermittently active beacon device may be configured to periodically enter the active state from the idle state. The intermittently active beacon device may be configured to continuously enter the active state from the idle state.

The intermittently active beacon device may be configured to operate intermittently according to a duty cycle. Whilst in the active part of the duty cycle (the active state), the beacon device may periodically send messages. The period may be regular or irregular. The beacon device may periodically broadcast messages that can be received by mobile devices within the range of the beacon device. During the inactive part of the duty cycle (the idle state) the beacon device may send no messages.

The mobile device may be stationary. The mobile device may be within range of the intermittently active beacon device and/or the one or more positioning beacons. The mobile device may not move out of range of the intermittently active beacon device and/or one or more of the positioning beacons, and/or into range of the intermittently active beacon device and/or one or more of the positioning beacons.

At the time of receiving the beacon message, the mobile device may be within range of the intermittently active beacon device and/or one or more of the positioning beacons.

The intermittently active beacon device may be configured to broadcast the beacon message in response to entering the active state. The intermittently active device may periodically broadcast the beacon message when it is in the active state (i.e. during the active part of the duty cycle).

The intermittently active beacon device may have an idle state and an active state. The one or more processors may be configured to cause the beacon device to intermittently enter the active state from the idle state. On entering the active state, the one or more processors may cause the beacon device to repeatedly broadcast a beacon message. The beacon message may be configured to cause a mobile device receiving the beacon message to communicate with one or more positioning beacons.

According to another aspect, there is provided an intermittently active beacon device comprising one or more processors, the intermittently active beacon device having an idle state during which the intermittently active beacon device is not configured to broadcast beacon messages and an active state during which the intermittently active beacon device is configured to repeatedly broadcast a beacon message, the one or more processors being configured to cause the beacon device to intermittently enter the active state from the idle state, and on entering the active state, broadcast the beacon message, the beacon message configured to cause an operating system implemented by the mobile device to infer that a new beacon is visible to the operating system.

The intermittently active beacon device may operate according to a duty cycle comprising an active time during which the intermittently active beacon device is in the active state and an idle time during which the intermittently active beacon device is in the idle state, wherein the idle time is greater than a beacon lost timeout of the operating system of the mobile device. For example, the idle time may be at least 20 seconds.

According to a further aspect, there is provided a mobile device comprising one or more processors, the mobile device being configured to implement an operating system and an application and to: receive a beacon message from an intermittently active beacon device, the intermittently active beacon device being configured to intermittently enter an active state during which the intermittently active beacon device is configured to repeatedly broadcast a beacon message from an idle state during which the intermittently beacon device is not configured to broadcast beacon messages and on entering the active state, broadcast the beacon message, wherein the receipt of the beacon message causes the operating system implemented by the mobile device to infer that a new beacon is visible to the operating system; and in response to the operating system implemented by the mobile device inferring that a new beacon is visible to the operating system, wake the application to allow the application to perform a function

According to a further aspect, there is provided a method of waking an application implemented by a mobile device to perform a function, the method comprising: at an intermittently active beacon device having an idle state during which the intermittently active beacon device is not configured to broadcast beacon messages and an active state during which the intermittently active beacon device is configured to repeatedly broadcast a beacon message, the intermittently active beacon device being configured to intermittently enter the active state from the idle state, enter the active state and broadcast the beacon message; at mobile device configured to implement an operating system and an application, receive the beacon message from the intermittently active beacon device, wherein the receipt of the beacon message causes the operating system implemented by the mobile device to infer that a new beacon is visible to the operating system; and at the mobile device, in response to causing the operating system implemented by the mobile device to infer that a new beacon is visible to the operating system, the operating system is configured to wake the application to allow the application to perform a function.

The frequency of broadcast of the beacon message in the active state may be greater than the frequency of entering the active state from the idle state.

The frequency of broadcast of the beacon message in the active state may be greater than the frequency of changing between the active state and the idle state (i.e. from the active state to the idle state, or vice versa).

The idle time of the duty cycle of the intermittently active beacon may be greater than a time period predetermined by the operating system of the mobile device,

The idle time of the duty cycle of the intermittently active beacon may be greater than the length of time the operating system of the mobile device is configured to wait after receiving the last beacon message from a respective beacon before making a determination that the mobile device is no longer within range of the respective beacon.

According to a further aspect, there is provided a computer program comprising instructions that when executed by a computer cause the computer to perform the method above.

According to a further aspect, there is provided a computer-readable storage medium having stored thereon computer readable instructions that when executed at a computer (for example, comprising one or more processors) cause the computer to perform the method above. The computer-readable storage medium may be a non-transitory computer-readable storage medium. The computer may be implemented as a system of interconnected devices.

### BRIEF DESCRIPTION OF THE FIGURES

The present invention will now be described by way of example with reference to the accompanying drawings. In the drawings:

FIG. 1a schematically illustrates a building comprising multiple rooms, where each room contains a positioning beacon. The building also comprises an intermittently active beacon device. The system can be used to determine the location of a mobile device.

FIG. 1b schematically illustrates an example of a duty cycle of the intermittently active beacon described herein.

FIG. 2 schematically illustrates the determination of the location of a mobile device using two-way ranging.

FIG. 3 schematically illustrates the determination of the location of a mobile device using time difference of arrival.

FIG. 4 shows a flowchart showing the steps of an exemplary method of waking an application at a mobile device to allow it to perform a function using an intermittently active beacon device.

FIG. 5(a) shows an example of a mobile device and some of its associated components.

FIG. 5(b) shows an example of an intermittently active beacon device and some of its associated components.

### DETAILED DESCRIPTION

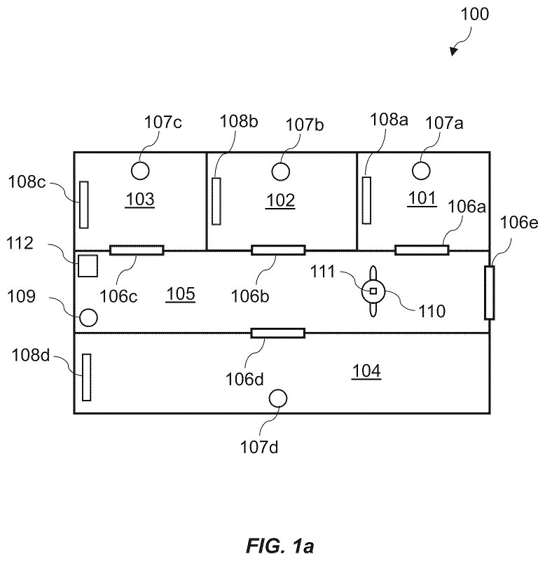

FIG. 1 shows an example of a building 100. In this example, the building 100 comprises multiple rooms 101, 102, 103, 104 and a corridor 105. Doors to each room 101, 102, 103, 104 from the corridor 105 are shown at 106a, 106b, 106c, 106d respectively. A door from the outside of the building to the corridor 105 is shown at 106e.

In this example, each room 101, 102, 103, 104 contains a positioning beacon 107a, 107b, 107c, 107d and a piece of computing equipment 108a, 108b, 108c, 108d. In this example, the positioning beacons are BLE beacons.

A user 110 carrying a mobile device 111 is shown inside the building 100. Such a device may comprise a smartphone, tablet or other mobile computing device. The device may be a user device. The device 111 may comprise a power source, such as a battery.

The positioning beacons 107a-d are communicatively connectable with the device 111 and may communicate with the device 111 by sending and/or receiving signals to and/or from the device 111. The communication between the device 111 and each of the positioning beacons is wireless. The mobile device 111 may communicate with one or more of the positing beacons 107a-d that it is within range of in order to determine the location of the mobile device 111. The location of the device 111 may be determined using any suitable known localization technique, such as signal strength measurements (for example, using one or more received signal strength indicators (RSSI)), time of flight or time difference of arrival of radio frequency radiation, as will be described in more detail below. The location may be determined coarsely (for example, to within a few meters, such as to indicate which room in a building the mobile device is located in).

The respective position of each of the positioning beacons may be fixed and/or known. The relative location of each positioning beacon may be known. The positioning beacons may have any location within or around the building or in the vicinity of it.

In a straightforward implementation, the positioning system may comprise multiple BLE beacons and the location of the mobile device may be determined using signal strength measurements (such as RSSI) from beacon messages received from each BLE beacon.

Optionally, each positioning beacon may run a clock having the same base as the other positioning beacons (i.e. the positioning beacons are time-synchronised). However, this is not essential and the implementation using multiple BLE beacons as positioning beacons and using signal strength measurements (such as RSSI) to determine the location of the mobile device does not require this.

Generally, there may be a single positioning beacon or multiple positioning beacons. A single positioning beacon may allow the measurement of distance and direction in the horizontal plane. By using multiple positioning beacons, as shown in FIG. 1, the device's location can be determined in 2D space (or in 3D space, if there are positioning beacons located at different height.

When using multiple positioning beacons, the location of the units may be fixed and/or known. For example, an administrator of a control system for the meeting rooms may correctly position the units on a map, such that location of each positioning beacon is known by the locating system relative to the meeting rooms. Alternatively, a location determination technique (for example using Bluetooth) may be used by the locating system to calculate the relative positions of the positioning beacons. In order to more accurately estimate the location of a device, the distances from the device to each positioning beacon may be taken at a similar time.

The device shown at 109 is an intermittently active beacon device. The intermittently active beacon device 109 may comprise a Bluetooth Low Energy beacon publisher. The intermittently active beacon device 109 has an idle state and an active state. The intermittently active beacon device 109 is configured to intermittently enter the active state from the idle state and on entering the active state, broadcast a beacon message.

The beacon device may enter the active state from the idle state periodically. The idle state may be a low-power state. In the idle state, the beacon device may be configured to save its current state to memory and shut down other components of the beacon device. The beacon device 109 does not broadcast beacon messages when it is in the idle state. The beacon device 109 can broadcast the beacon message repeatedly in the active state. The beacon message may be broadcast at regular or irregular intervals in the active state. The beacon device may be configured to start to broadcast the beacon message in response to entering the active state.

FIG. 1b schematically illustrates an example of a duty cycle of the intermittently active beacon.

The intermittently active beacon operates according to a duty cycle comprising an active time during which the intermittently active beacon is in the active state and an idle time during which the intermittently active beacon is in the idle state. t_{active} is the time period of the active time and t_{idle} is the time period of the idle time of the duty cycle. The frequency of entering the active state from the idle state is 1/(t_{active}+t_{idle}). The intermittently active beacon changes between the active state and the idle state when the beacon enters the active state from the idle state or enters the idle state from the active state. The active time and the idle time may be the same or may be different. The idle time may be greater than the active time. Where the active time and the idle time are the same, the frequency of changing between the active state and the idle state is 1/(0.5(t_{active}+t_{idle})).

Whereas a standard beacon operates to continuously output a beacon message at a predetermined time interval, the intermittently active beacon described herein continuously outputs a beacon message in the active state only. The intermittently active beacon is configured to intermittently and/or repeatedly transmit a beacon message in the active state. The active state is a state in which the intermittently active beacon is configured to intermittently and/or repeatedly broadcast a beacon message. During the active state, the beacon message broadcast frequency may be the same as for a regular beacon, where the beacon message is continually broadcast all the time that the regular beacon is operating. During t_{active}, the intermittently active beacon broadcasts multiple beacon messages. t_{b} is a time period between the start of each beacon message broadcast in the active state. The frequency of broadcast of the beacon message in the active state is 1/t_{b}. t_{b} may be, for example, between 0.1-1 seconds. The frequency of broadcast of the beacon message in the active state may be between 1-10 Hz.

During the idle state of the intermittently active beacon, the intermittently active beacon does not broadcast (i.e. never broadcasts) the beacon message. During t_{idle}, the intermittently active beacon broadcasts no beacon messages. The idle state is a state in which the intermittently active beacon is configured to not broadcast beacon messages. Put another way, the idle state is a state in which the intermittently active beacon is configured to broadcast no beacon messages.

The frequency of broadcast of the beacon message in the active state is greater than the frequency of entering the active state from the idle state. The frequency of broadcast of the beacon message in the active state is greater than the frequency of changing between the active state and the idle state.

t_{active} and/or t_{idle} may be configured by a user for waking up the application at predetermined intervals. In some implementations, t_{active} and t_{idle} may be approximately equal. t_{active} and t_{idle} may in some implementations each be greater than 1 minute.

t_{idle} may be greater than a predetermined time period, which may be predetermined by the mobile device or its operating system.

When the beacon device enters the active state from the idle state, the reception of the beacon message by the mobile device causes the operating system implemented by the mobile device to infer that a new beacon is visible to the operating system. In other words, the operating system may infer that the mobile device is within range of a new beacon. In response to causing the operating system implemented by the mobile device to infer that a new beacon is visible to the operating system, the operating system can wake (e.g. activate) the application to allow the application to perform a function.

For example, the receipt of the beacon message may cause the operating system to wake the application and cause the mobile device to communicate with one or more of the positioning beacons to allow the location of the mobile device to be determined, as will be described in more detail below.

When the mobile device 111 is in range of the beacon device 109, it can receive a beacon message from the beacon device 109 that is sent when the beacon device enters the active state from the idle state. The beacon device 109 can repeatedly broadcast the beacon message in the active state. It may broadcast the beacon message at regular intervals.

The mobile device 111 is configured to, in response to receiving the beacon message, wake the application.

For example, the mobile device 111 may be configured to, in response to receiving the beacon message after the beacon device 109 has entered the active state, wake the application and perform one or more measurements with the one or more positioning beacons. The location of the mobile device 111 may be determined based on the one or more signal strength measurements. The determined location may be used by an application running on the mobile device. The location may be sent to one or more other entities.

As mentioned above, the mobile device 111 may be configured to implement an application. The beacon message may be configured to cause the application on the mobile device to be activated. It may do this by the application being woken by the operating system of the mobile device.

The application at the mobile device can wake up at approximately the frequency of the changes between the active and inactive states of the intermittently active beacon. The frequency of the change between the active and inactive states of the intermittently active beacon is greater than that of the beacon message broadcast in the active state (for example, minutes vs<1 second). When the application wakes up, it can perform a function.

Times b_{f}, w₁, w₂ and w₃ are shown in FIG. 1b.

The intermittently active beacon device enters the active state from the idle state. At time w₁, a first beacon message is transmitted by the intermittently active beacon device at the start of the active part of the cycle (at the start of the active time). This first beacon message is received by the mobile device on (assuming instantaneous reception) or shortly after (for non-instantaneous reception) time w₁ (i.e. upon the intermittently active beacon device entering the active state from the idle state). The operating system can wake up the application because the intermittently active beacon is seen (i.e. the mobile device receives beacon messages from the intermittently active beacon). In other words, the intermittently active beacon is visible to the operating system.

Time b_{f} corresponds to the end of the active time of the cycle of the intermittently active beacon. At time b_{f}, a beacon message is transmitted by the intermittently active beacon. This beacon message is the final beacon message of the multiple beacon messages broadcast by the intermittently active beacon device in the active state for that cycle. Time b_{f} is at the end of the active time of a first duty cycle of the intermittently active beacon. This final beacon message is received by the mobile device on (assuming instantaneous reception) or shortly after time b_{f}.

A time tₗ after the reception of the final beacon message of a respective active time of the intermittently active beacon, the intermittently active beacon is forgotten by the operating system of the mobile device. This is shown at time w₂ in FIG. 1b. The time period tₗ is predetermined by the operating system of the mobile device. This time period is the length of time the operating system of a mobile device is configured to wait after seeing the last beacon message from a respective beacon before making the determination that the mobile device is no longer within range of the respective beacon. In other words, the operating system determines that the mobile device is no longer within the range of a respective beacon when it does not receive a beacon message from the respective beacon within a predetermined time period tₗ since it last received a beacon message from the respective beacon. This time period is referred to herein as a beacon lost timeout period of the operating system.

At time w₂, the operating system of the mobile device can wake up the application because the intermittently active beacon is no longer seen by (i.e. visible to) the operating system. That is, the operating system determines that the mobile device is no longer in range of the intermittently active beacon.

No beacon messages are broadcast by the intermittently active beacon in the idle state, corresponding to the time period t_{idle} between times b_{f} and w_{3.}

At time w₃, at the start of the active time of a second cycle, the intermittently active beacon enters the active state and broadcasts a first beacon message of the second cycle. The operating system can wake up the application because the intermittently active beacon is seen by (i.e. is visible to) the operating system (i.e. the mobile device receives a beacon message from the intermittently active beacon). The operating system can infer that a ‘new’ beacon is visible to the operating system (i.e. the mobile device is within range of the ‘new’ beacon). The time periods t_{active} and t_{idle} can be controlled to control the desired wake up interval for the application, for example every 5 minutes.

Positioning beacons are transmitting (and optionally receiving) devices which can produce regular transmissions of a unique identifier. The beacon message sent by a beacon device can include a region identifier, which can be recognized by the mobile operating system and can be used to inform the mobile device, or an application implemented thereon, that a particular region has been entered by the mobile device, Operating systems of a mobile device can allow an application to register to be woken up if they come within range of a positioning beacon device, such as a BLE beacon. At this transition, the application has a short time to run some code but generally returns to sleep within a few seconds. The range of a beacon can be large, so once a device is in range of the beacon (and the mobile device continues to receive beacon messages having a particular region identifier), the application will not be re-woken for that beacon until the device goes out of range of the beacon. After the operating system has gone some period of time without seeing a beacon message having a particular region identifier (which may be referred to as the beacon lost timeout period), it can wake the application to report that the mobile device is no longer in the region corresponding to the particular region identifier.

By intermittently entering an active state, the operating system of the mobile device can notify applications running on the mobile device that a new beacon device has become visible, which can allow the application to be activated and for the mobile device to perform a function, such as performing location determination measurements with one or more positioning beacons that it is within range of, without needing to go out of range of those positioning beacons and/or re-enter the range of those positioning beacons.

Periodically, for example every few minutes, the intermittently active beacon device can be programmed to wake up from its idle state and enter an active state, where it starts signalling to repeatedly broadcast a beacon message, for example by sending a beacon message at regular intervals for several seconds. The intermittently active beacon device then returns to the idle state. When the mobile device receives the first beacon message when the intermittently active beacon device enters the active state, the mobile operating system of the mobile device thinks that the mobile device has entered the range of a new beacon device and so will wake the application. The application can then perform a function, such as requesting signal strength measurements for all visible positioning beacons (i.e. with all positioning beacons that the mobile device is within range of) from the operating system and can determine the location of the mobile device, for example the current room that the mobile device is in within a building.

The mobile device may be configured to monitor region identifiers of received beacon messages. The beacon message received from the intermittently active beacon device may contain a first region identifier. When the mobile device receives the beacon message containing the first region identifier, the operating system can wake the application to inform the application that the mobile device is in an area corresponding to the first region identifier.

When the mobile device has not detected a beacon message containing the first region identifier for at least a predetermined period (which may be less than the duration of the idle state of the duty cycle of the intermittently active beacon), the operating system may be configured to wake the application to inform the application that the mobile device is no longer in an area corresponding to the first region identifier.

When the intermittently active beacon device next enters the active state, the process can start again and upon receiving the beacon message containing the first region identifier, the operating system will infer that it has come into the range of a new beacon (i.e. one that has not been seen for at least the beacon lost timeout period, and so it has been removed from the record of observed beacons at the mobile device). The operating system will then again wake up the application. Thus the duty cycle of the intermittently active beacon device having an idle state that is greater than the beacon lost timeout period of the operating system allows the operating system to wake the application each time the intermittently active beacon device enters the active state and broadcasts the beacon message.

In response to the mobile device receiving the message, the operating system can infer that a new beacon is visible and the application may receive a notification from the operating system of the mobile device that a new beacon is in range of the device. The operating system may send the notification to the application in response to the mobile device receiving the message from the beacon. The application may then request measurements (such as RSSI) for all positioning beacons within range of the mobile device from the operating system. The mobile device may perform measurements for each of the beacons. For example, this may be done by measuring the strength of the signals received from them. The application may perform location determination using data received from the operating system, which may include the signal strength measurements for each positioning device. In other implementations, the operating system of the mobile device may perform ranging calculations that are provided to the application. In some implementations, the operating system may determine the location of the device and provide the location to the application.

This enables the application to periodically sample the beacon landscape even though the user is not moving or entering/leaving the range of one or more beacons.

As mentioned above, the intermittently active beacon device 109 may be configured to operate intermittently according to a duty cycle. Whilst in the active part of the duty cycle (the active state), the beacon device periodically sends messages. The beacon device may periodically broadcast a message that can be received my mobile devices within the range of the beacon device. These messages may for instance be sent with a period of between 100 ms to 900 ms. During the inactive part of the duty cycle (the idle state) the beacon device sends no messages.

The duty cycle may be tuned such that the idle time (i.e. the length of the idle/inactive part of the duty cycle) is greater than a predetermined time period, which may be predetermined by the operating system of the mobile device, such as the beacon lost timeout of the operating system of the mobile device, which may typically be 20 or 30 seconds. The idle time may be less than the period at which the overall system desires to maintain the device location. The active time may only be long enough for mobile devices in the area to detect the signal. The signal detection time once active may be less than 10 seconds. For more reliable detection, the detection time may be up to 30 seconds. The detection time may be dependent on the operating system used. In one example, the active part of the duty cycle may be up to 30 seconds and the inactive part of the duty cycle may be up to 5 minutes.

Therefore, when the intermittently active beacon device transitions from the idle state to the active state, one or more mobile devices within range of the intermittently active beacon device can receive the beacon message from the intermittently active beacon device and give an indication to the operating system of the respective device(s) that a new beacon device has been observed. In response, the operating system can notify the application, which can wake up the application. The application, or the operating system, then has opportunity to perform signal strength measurements with all the observed positioning beacons in the area (i.e. positioning beacons within range of the mobile device). The application can also be woken at time tₗ from when the intermittently active beacon transitions from the active state to the idle state. This effectively gives the application a sampling technique for accurate location determination within the building at the period of the duty cycle of the intermittent beacon.

The system may have a trade-off between the sampling period and the effect on the battery life of the mobile device. A shorter sampling period will have a negative impact on the battery life of the device, but a longer sampling period will result in a less detailed location history for the device.

As the intermittently active beacon device transitions to the active state from the idle state, the mobile device may be stationary. The mobile device may not move out of range of one or more of the positioning beacons and/or into range of one or more of the positioning beacons. At the time of receiving the beacon message from the intermittently active beacon device, the mobile device may be within range of the one or more of the positioning beacons. At the time of receiving a subsequent beacon message from the intermittently active beacon device, which may be sent during the active time of a different duty cycle than the previous message, the mobile device may be within range of the one or more of the positioning beacons.

In the above-described examples, the positioning beacons may be BLE beacons which transmit messages that can be received by mobile device and used to determine the signal strength of signals received from each positioning beacon, which can be used to determine the location of the mobile device relative to one or more positioning beacons using known localisation techniques, for example as described at https://developer.apple.com/documentation/corelocation/determining-the-proximity-to-an-ibeacon-device.

The following describes optional enhancements to determining the position of the device using received signals strength measurements, as described above. The techniques described below may be used to determine the location of the device where the positioning beacons are clock-synchronised and/or may receive signals from the mobile device as well as transmit messages to the mobile device (i.e. where two-way communication between the mobile device and the positioning beacons is possible).

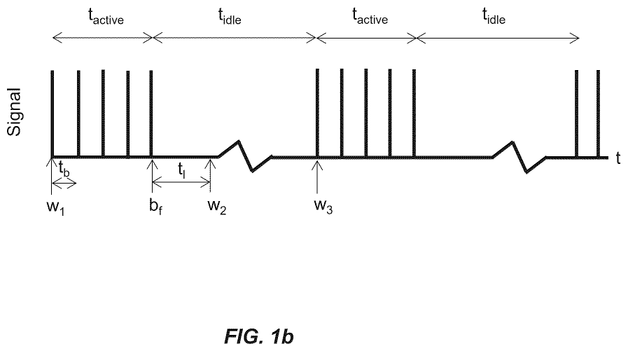

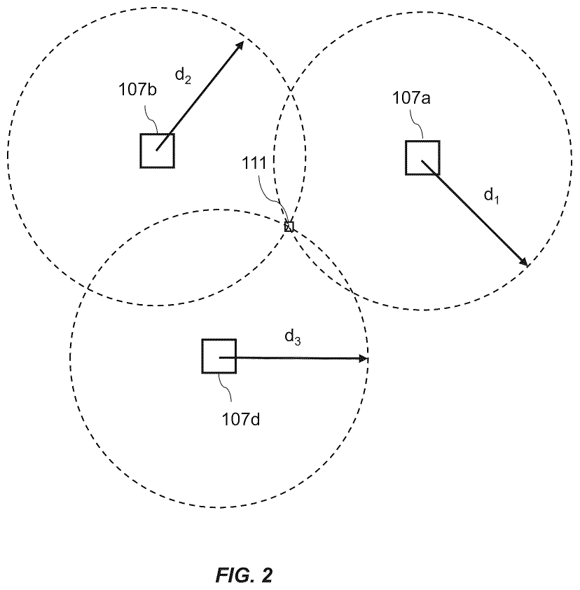

As schematically illustrated in FIGS. 2 and 3, the position of the mobile device 111 may optionally be determined based on radio frequency (RF) signals sent or received by the mobile device 111. The system may use a localization technique, such as time of flight (ToF) or time difference of arrival (TDoA) of transmitted radio frequency signals, to determine the position of the mobile device 111. The system may use trilateration of radio frequency signals sent between the mobile device 111 and each positioning beacon (with positioning beacons 107a, 107b and 107d shown in FIGS. 2 and 3 as examples) to determine the position of the mobile device 111. In this example, the RF radiation is transmitted using Bluetooth (RTM).

The position of the mobile device 111 at a given time may be determined based on measurements of RF signals transmitted by the mobile device 111 and/or the positioning beacons. The measurements may be based on ToF and/or Angle of Arrival (AoA), or TDoA. In principle, if the transmitter (which could be the mobile device or a positioning beacon) and the receiver were time-synchronised to a high precision then a signal to/from one positioning beacon would give an indication of the distance between the device and the positioning beacon. In practice, devices are often not sychronised to a high level of precision, so multiple fixed devices whose relative locations are known can be used, and signals are sent between them, one way or the other. The use of such a system does not require precise synchronisation between the fixed positioning beacons and the mobile device. Synchronisation between the fixed positioning beacons is easier to achieve because, for example, the units could be wired to a network with their clocks synchronised.

Therefore, the mobile device 111 may transmit signals that are received by the positioning beacon(s), or alternatively the positioning beacon(s) may transmit signals that are received by the device, and ToF, AoA or TDoA measurements may be used to determine the absolute or relative location of the mobile device.

In FIG. 2, the location of the mobile device 111 is determined from ToF measurements between the mobile device 111 and each of the positioning beacons 107a, 107b, 107d. A two-way ranging method can be used to determine the time of flight of the radio frequency signal between the mobile device and each of the positioning beacons, which can then be used to calculate the distance between the mobile device and each of the positioning beacons by multiplying the time of flight by the speed of light.

In one implementation, the mobile device 111 may initiate the two way ranging process by sending a poll message to a known address of a positioning beacon at a time referred to as the time of sending poll (TSP). The positioning beacon can record the time of poll reception (TRP) and replies with a response message at a time of sending response (TSR). Upon reception of the response message, the mobile device records the time of reception of response (TRR) and composes a final message to send to the positioning beacon, where the ID of the device, TSP, TRR and time of sending final message (TSF) are included. Based on the time of reception of the final message (TRF) at the positioning beacon and the information provided in the final message, the respective positioning beacon can determine the time of flight of the radio frequency signal. This can be multiplied by the speed of light to determine the distance between the mobile device and the respective positioning beacon.

For a respective positioning beacon, the distance between the mobile device and the positioning beacon can be determined as follows:

$$ToF = [ ( TRR - TSP ) - ( TSR - TRP ) + ( TRF - TSR ) - ( TSF - TRR ) ] / 4$$

$$distance = ToF \times ( speed of light )$$

This process can be performed for all positioning beacons. Optionally, the distance can be determined by an entity external to the mobile device and sent back to the mobile device.

Alternatively, the positioning beacons may each send a poll message to the mobile device at TSP which is received at the device at TRP, which sends a response message back to the respective positioning beacon at TSR, before the final message is sent back to the mobile device at TSF. The distance can be determined as above at the mobile device, or the time data can be sent to another entity for processing.

After the ranging process has been performed for all of the positioning beacons, each unit 107a, 107b, 107d has a corresponding distance d₁, d₂, d₃ from the device 111, as shown in FIG. 2. The intersection of three circles with radii d₁, d₂, d₃ can be used to determine the location of the mobile device 111.

In the example shown in FIG. 3, a radio-frequency signal is transmitted by the mobile device 111. The signal is captured at positioning beacons 107a, 107b and 107d, which are within range of the device 111. Using this scheme, the positioning beacons are running the same clock.

The mobile device 111 can transmit a short Blink message at regular intervals (known as the refresh rate). Generally, the Blink message is processed by all of the positioning beacons in the communication range. The positioning beacons each send respective time stamps for the time when they received the Blink message to the mobile device or external entity. To calculate the location of the device 111, the mobile device or external entity may only consider timestamps coming from at least three positioning beacons with the same clock base.

The signal captured at each positioning beacons is shifted in time to find a position of maximum alignment. The time shift necessary to align each received signal is multiplied by the speed of light to obtain a distance difference between each receiver. The distance difference can be plotted as a set of hyperbolic lines. In FIG. 3, two hyperbolic lines are shown, one for the a first time difference (TD1) between the time of arrival of the Blink message at unit 107b and 107d (Tb−Tc) and a second for a second time difference (TD2) between the time of arrival of the Blink message at unit 107b and 107a (Tb−Ta). The intersection of the lines indicates the location of the mobile device 111.

If the locations of the positioning beacons are known, this can be used to determine the absolute location of the mobile device, or its location relative to other entities with known locations (such as the access control readers or other points of reference at the access point).

When using the TDoA method, the mobile device 111 does not communicate with the positioning beacons individually and does not know their addressing range. This can lead to prolonging of battery life relative to two way ranging methods, since the mobile device can send only one Blink message in order to be localized in space. In comparison, two way ranging methods use the exchange of 9 messages to localize the device using trilateration. Therefore, using TDoA, the battery life of the mobile device may be prolonged.

In other implementations, the positioning beacons may each act as transmitters and may each emit a radio frequency signal. The mobile device may act as the receiver and receive the signals from each of the positioning beacons. The time of arrival measurements can be used in the same way as described above to determine the position of the mobile device. The receiving device(s) can forward data relating to the received signals to the mobile device or an external entity, which can process the data to determine the location of the device.

If it is detected that the power level is below a predetermined level, the mobile device may only use TDoA, rather than two way ranging, for example. Alternatively, the location may be determined using ToF data using two way ranging from one of the positioning beacons, rather than for three, which may be more computationally expensive, and thus use more power from the power source.

Mechanisms such as TDoA may be used to allow devices to calculate the distance from the mobile device to all positioning beacons with a single Blink message, which has significantly reduced power requirements for the device, or Reverse TDoA, which allows multiple devices to calculate their distances to multiple positioning beacons. To do this, it is preferable that the clocks of the positioning beacons are closely synchronised. Synchronising clocks is easier if all of the positioning beacons are connected to the same controller. Clocks may alternatively be synchronised over for communication protocol such as Bluetooth (RTM).

Embodiments of the present invention can exploit the beacon-detected (when the device moves into range of a beacon device) and beacon-lost (when the device moves out of range of a beacon device) indications that a mobile operating system gives to an application when a new beacon is detected, or a known beacon is no longer detected. During these indications, the application is given the opportunity to perform ranging with nearby beacons even though the application is not running in the foreground.

The beacon device 109 may be implemented at a computer system and powered from the building power supply. This means that the power output of the beacon device can be significantly higher than a typical battery powered beacon, so it may cover the entirety of a small building. Multiple intermittent beacon devices may be used to cover a larger building.

The mobile device may be further configured to, in dependence on the location of the mobile device, perform an action. The mobile device may be configured to determine which of multiple rooms in the building it is located in. The action may comprise establishing a connection with a piece of equipment. For example, a piece of computing equipment, such as a videoconferencing system or display equipment, such as a display screen, located in the room that the mobile device is determined to be in. The piece of equipment may be in proximity to the determined location. The piece of equipment may be within a predetermined range of the determined location. For example, the determined location of the device may be used to connect the device to the closest piece of equipment to the mobile device, or to a piece of equipment that is known to be located in the same room as the mobile device.

The determined location of the mobile device may be used to establish the proximity of the mobile device to a piece of equipment. The mobile device may be configured to trigger a connection to allow control of, and/or data sharing with, the piece of equipment. The piece of equipment may have been determined to be the piece of equipment in closest proximity to the mobile device.

Possible further uses of the location sampling system described herein include room occupancy monitoring/tracking, interfacing a mobile device owner's device with a room's audio-visual system, monitoring for access control security violations, routing of communications to physical locations, health and safety of personnel, time management, productivity optimisation, compliance and accountability, and asset tracking.

In one example, a virtual office provider may want to track occupancy of meeting rooms for accurate billing of meeting room use. Once the location of the user device has been accurately determined, the device may report its location to a control entity that can log how many users are in each meeting room and the periods of times that the rooms are occupied by the users.

In another example, a videoconferencing provider may want to offer a streamlined experience for a user in a videoconference when they enter a shared meeting room.

When a user's mobile device is detected as entering a shared meeting room, which may be one or multiple meetings rooms all within range of one or more positioning devices, the mobile device may establish a connection with a piece of audiovisual equipment. The piece of audiovisual equipment may be in proximity to the determined location, for example within a predetermined range of the determined location. This may allow a user's phone to be automatically connected to the audiovisual equipment when they enter a meeting room. Alternatively, the mobile device may present a notification to the user that they are detecting as being in the meeting room and asking them to authorized the connection of the mobile device to the piece of audiovisual equipment. The piece of audiovisual equipment may be a videoconferencing end-system, or a part thereof. This may allow the user to share media with participants of a videoconference.

In another example, the determined location of the mobile device may be used by a company who may want to know if personnel are detected in rooms that they are not authorized to enter. The mobile device may notify a computing entity of the device's determined location.

An organization with fixed-line communications may wish to route incoming calls destined for a person to the location of that person. A control system may automatically direct a call to a fixed-line telephone located in the room that a person has been determined to be in, or to a video conferencing end-system of that room. The control system may determine the user's location from a room occupancy monitoring entity.

An organization may wish to know how long employees are spending in break areas for reasons of resource management, policy compliance or fairness. For example, an organization may wish to know how long employees are spending in different work areas to identify bottlenecks in movement or processes. This may also give insight into employee behaviour and detect signs of job dissatisfaction or burnout, signalling a need for management intervention.

An organization subject to compliance regulations may need to know the physical locations of employees to satisfy requirements regarding cross-contamination or access to sensitive areas.

An organization may benefit from an audit trail of staff using a storage location to identify custody of missing shared assets, or may wish to know the precise location of employees in case of emergency in order to direct first responders to their location.

In another example, for example during a pandemic, an organization may monitor, audit and enforce social distancing protocols that limit the number of staff sharing a working environment.

Other implementations are possible.

Although the examples described herein mainly relate to location determination, the intermittently active beacon device may also be used to wake an application on a mobile device to allow it to perform a different function. Such functions may include measuring audio levels, scanning for a WiFi (RTM) or mobile network, or reporting other measured parameters to another entity.

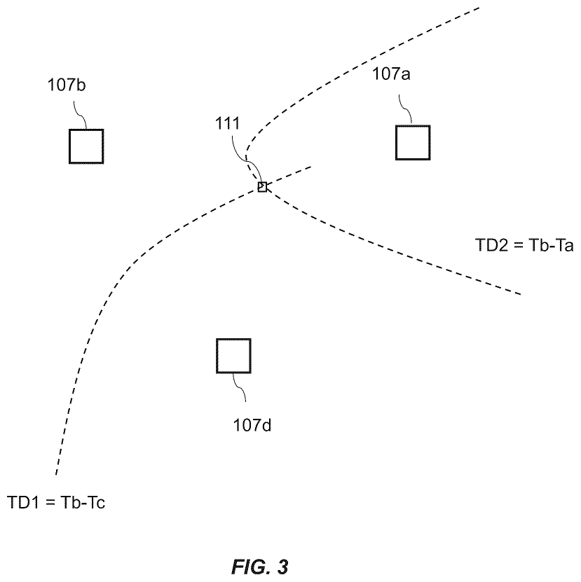

FIG. 4 shows an example of a method of waking an application implemented by a mobile device using an intermittently active beacon. At step 401, the method comprises at the intermittently active beacon device having an idle state during which the intermittently active beacon device is not configured to broadcast beacon messages and an active state during which the intermittently active beacon device is configured to repeatedly broadcast a beacon message, the intermittently active beacon device being configured to intermittently enter the active state from the idle state, entering the active state and repeatedly broadcast a beacon message.

At step 402, the method comprises, at mobile device configured to implement an operating system and an application, receiving the beacon message from the intermittently active beacon device, wherein the receipt of the beacon message causes the operating system implemented by the mobile device to infer that a new beacon is visible to the operating system.

At step 403, the method comprises, at the mobile device, in response to causing the operating system implemented by the mobile device to infer that a new beacon is visible to the operating system, waking the application to allow the application to perform a function.

As described above, the duty cycle of the intermittently active beacon comprises an active time when the beacon is in the active state and an idle time when the beacon is in the idle state. The intermittently active beacon has two modes—non-transmitting (in the idle state) and intermittently transmitting (in the active state). The intermittently active beacon cycles between these two modes at a lower frequency that the frequency of the intermittent transmission of the beacon message in the active state.

The intermittent transmission is the normal operation of standard beacons. A mobile device determines that it is within range of a beacon if it has received a transmission from that beacon (for example, a beacon message) within a predetermined period since the last received transmission from that beacon, for example within the period tₗ shown in FIG. 1b, which is the length of time the operating system of a mobile device is configured to wait after receiving the last beacon message from a respective beacon before making the determination that the mobile device is no longer within range of the respective beacon. This may be, for example, up to a minute or two. For normal beacon usage, the mobile device starts to receive beacon messages when the mobile device enters a position within the range of the beacon, and so this triggers the mobile operating system to notify the application that it has entered within the beacon's range, waking up the application. When the mobile device leaves the range of the beacon, it no longer sees the beacon message transmissions, and so once the operating system of the mobile device determines that the mobile device is no longer within range of the respective beacon, this triggers the operating system to notify the application that it has left the range of the beacon, again waking up the application.

The intermittently active beacon described herein can allow for lower frequency control, so that the intermittently active beacon will transmit a beacon message at a higher frequency for the active time (for example, five minutes of transmitting every second), and then it will cease transmission for a similar period for the idle time. This appears to the mobile operating system that the mobile device is in the beacon region for five minutes, and then leaves it for five minutes, then re-enters for five minutes, etc. This can cause the operating system to regularly wake up the application on a frequency that can be pre-determined.

A wake up of the application can be used to measure the signal strength of all nearby beacons, and so it can be estimated not just which beacons are visible, but also which beacon is closest to the mobile device. Because conventional beacon usage only wakes up the application when it first sees a beacon, or stops seeing a beacon, this means that if the mobile device is within range of two beacons for an extended duration, the application will not be woken. Although the device might be moving around within range of those beacons, because the mobile operating system does not wake the application (as the set of beacons within range does not change), the application has no way of observing this movement.

The intermittently active beacon described herein can cause the regular waking up of the application, meaning that even if the set of beacons within range of the mobile device does not change, periodic (at a chosen, predetermined period) sampling of the signal strengths of all beacons within range may be performed, for example even when an application is running as a background application.

The mobile device 111, intermittently active beacon device 109 and each positioning beacon 107a-d may each comprise a processor and a memory. The processor may be implemented as dedicated hardware in the device, such as a processing chip. The memory is arranged to communicate with the respective processor. Memory may be a non-volatile memory. Each device may comprise more than one processor and more than one memory. The memory may store data that is executable by the processor. By executing program code contained in such data, the one or more processors may perform functions as described herein. The memory may store such program code in a non-transitory manner. The processor may be configured to operate in accordance with a computer program stored in non-transitory form on a machine readable storage medium. The computer program may store instructions for causing the processor to perform its methods in the manner described herein.

Each of the mobile device, each positioning beacon and the intermittently active beacon device may also comprise a transceiver for receiving and/or sending data from and/or to one or more of the other entities.

Each device also comprises a power source or is connectable to mains power. The mobile device may comprise a battery, as discussed above. This allows the mobile device to be portable and carried by a user. The battery may be rechargeable and/or replaceable.

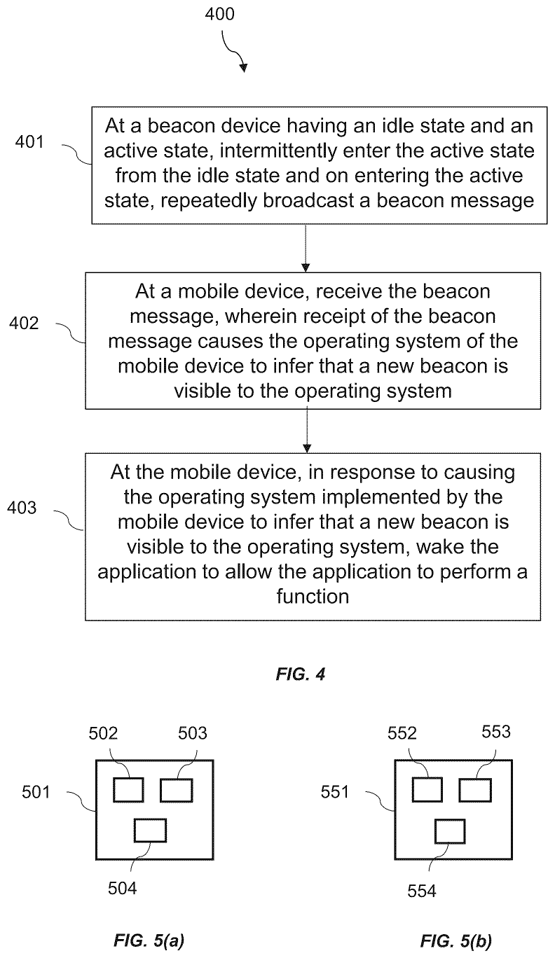

FIG. 5(a) shows an example of a device 501 that may be a mobile device, such as a mobile phone. The device 501 comprises a processor 502, a memory 503 and a transceiver 504. FIG. 5(b) shows an example of a device 551 that may be an intermittently active beacon device. The device 551 comprises a processor 552, memory 553 and a transceiver 554. The processor of the control unit could be implemented as a physical processing unit or could be a logical function that is distributed between multiple physical processing units.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. The applicant indicates that aspects of the present invention may consist of any such individual feature or combination of features. In view of the foregoing description, it will be evident to a person skilled in the art that various modifications may be made within the scope of the invention.

1. A system comprising:
an intermittently active beacon device configured to operate according to a duty cycle comprising an active time during which the intermittently active beacon device is in an active state and an idle time during which the intermittently active beacon device is in an idle state, wherein in the idle state the intermittently active beacon device is not configured to broadcast beacon messages and in the active state the intermittently active beacon device is configured to repeatedly broadcast a beacon message, the intermittently active beacon device being configured to intermittently enter the active state from the idle state and on entering the active state, repeatedly broadcast the beacon message, wherein the frequency of broadcast of the beacon message in the active state is greater than the frequency of entering the active state from the idle state; and
a mobile device configured to implement an operating system and an application, wherein the mobile device is configured to, upon the intermittently active beacon device entering the active state from the idle state:
receive the beacon message from the intermittently active beacon device, wherein the receipt of the beacon message causes the operating system implemented by the mobile device to infer that a new beacon is visible to the operating system; and
in response to causing the operating system implemented by the mobile device to infer that a new beacon is visible to the operating system, the operating system is configured to wake the application to allow the application to perform a function;
wherein the idle time of the duty cycle of the intermittently active beacon device is greater than a time period predetermined by the operating system of the mobile device.

2. The system as claimed in claim 1, wherein the frequency of broadcast of the beacon message in the active state is greater than the frequency of changing between the active state and the idle state.

3. The system as claimed in claim 1, wherein the frequency of broadcast of the beacon message in the active state is between 1 to 10 Hz.

4. The system as claimed in claim 1, wherein the mobile device is configured to monitor region identifiers of received beacon messages and wherein the beacon message received from the intermittently active beacon device contains a first region identifier, wherein when the mobile device receives the beacon message containing the first region identifier, the operating system is configured to wake the application to inform the application that the mobile device is in an area corresponding to the first region identifier.

5. The system as claimed in claim 4, wherein when the mobile device has not detected a beacon message containing the first region identifier for at least the time period predetermined by the operating system, the operating system is configured to wake the application to inform the application that the mobile device is no longer in an area corresponding to the first region identifier.

6. The system as claimed in claim 1, wherein the time period predetermined by the operating system is a length of time the operating system of a mobile device is configured to wait after receiving the last beacon message from a respective beacon before making the determination that the mobile device is no longer within range of the respective beacon.

7. The system as claimed in claim 1, wherein the function comprises determining the location of the mobile device.

8. The system as claimed in claim 7, wherein the system comprises one or more positioning beacons, wherein the mobile device is located so as be able to receive respective signals from the one or more positioning beacons, wherein the application is configured to request the operating system to perform one or more measurements of the signals received from the one or more positioning beacons.

9. The system as claimed in claim 8, wherein the system comprises a computing entity configured to determine, in dependence on the measurements of the signals received from the one or more positioning beacons, a status of the mobile device and/or one or more of the positioning beacons.

10. The system as claimed in claim 9, wherein the mobile device is configured to determine in which of multiple rooms the device is located based on the determined location.

11. The system as claimed in claim 8, wherein the one or more measurements are signal strength measurements.

12. The system as claimed in claim 8, wherein the mobile device is configured to:
perform two-way ranging with at least one of the one or more positioning beacons; and
determine the location of the mobile device based on the two-way ranging.

13. The system as claimed in claim 7, wherein the mobile device is further configured to, in dependence on the determined location, perform an action.

14. The system as claimed in claim 13, wherein the action comprises establishing a connection with an entity external to the mobile device.

15. The system as claimed in claim 7, wherein the mobile device is configured to report the determined location to another entity.

16. The system as claimed in claim 1, wherein the one or more positioning beacons and/or the intermittently active beacon device comprise(s) a Bluetooth Low Energy beacon publisher.

17. The system as claimed in claim 1, wherein in the idle state, the intermittently active beacon device is configured to save its current state to memory and shut down other components of the intermittently active beacon device.

18. The system as claimed in claim 1, wherein the beacon device is configured to periodically and/or continuously enter the active state from the idle state.

19. An intermittently active beacon device comprising one or more processors, the intermittently active beacon device having an idle state during which the intermittently active beacon device is not configured to broadcast beacon messages and an active state during which the intermittently active beacon device is configured to repeatedly broadcast a beacon message, the one or more processors being configured to cause the beacon device to intermittently enter the active state from the idle state, and on entering the active state, repeatedly broadcast a beacon message, the beacon message configured to cause an operating system implemented by the mobile device to infer that a new beacon is visible to the operating system, wherein the frequency of broadcast of the beacon message in the active state is greater than the frequency of entering the active state from the idle state.

20. A method of waking an application implemented by a mobile device to perform a function, the method comprising:
at an intermittently active beacon device configured to operate according to a duty cycle comprising an active time during which the intermittently active beacon device is in an active state and an idle time during which the intermittently active beacon device is in an idle state, wherein in the idle state the intermittently active beacon device is not configured to broadcast beacon messages and in the active state the intermittently active beacon device is configured to repeatedly broadcast a beacon message, the intermittently active beacon device being configured to intermittently enter the active state from the idle state, and on entering the active state repeatedly broadcast a beacon message, wherein the frequency of broadcast of the beacon message in the active state is greater than the frequency of entering the active state from the idle state;
at mobile device configured to implement an operating system and an application, receive the beacon message from the intermittently active beacon device, wherein the receipt of the beacon message causes the operating system implemented by the mobile device to infer that a new beacon is visible to the operating system; and
at the mobile device, in response to causing the operating system implemented by the mobile device to infer that a new beacon is visible to the operating system, the operating system is configured to wake the application to allow the application to perform a function;
wherein the idle time of the duty cycle of the intermittently active beacon device is greater than a time period predetermined by the operating system of the mobile device.
